(19) United States
(12) Patent Application Publication
(10) Pub. No.: US 2019/0367745 A1
(43) Pub. Date: Dec. 5, 2019

(54) SIDE PASSIVATION

(71) Applicant: BIOLOGISCHE INSEL LOTHAR MOLL GMBH & CO. KG, Schwetzingen (DE)

(72) Inventor: Slobodan MITROVIC, Schwetzingen (DE)

(21) Appl. No.: 16/489,481

(22) PCT Filed: Mar. 2, 2018
(86) PCT No.: PCT/EP2018/055168

§ 371 Date: Aug. 28, 2019

(30) Foreign Application Priority Data
Mar. 2, 2017 (DE) 10 2017 104 408.6

(51) Int. Cl. C09D 5/20; B65H 18/28; C09J 7/20

(52) U.S. Cl. CPC C09D 5/20; B65H 2301/5114; C09J 7/20; B65H 18/28

(57) ABSTRACT

Production of a passivation layer from at least one mass, the mass forming a tearable protective layer for a first side surface of an adhesive roll after drying and/or after a chemical reaction. Performing the passivation of a side surface of an adhesive roll more quickly and also in a simpler manner is provided by a method having the following steps: a) applying at least one first layer of the mass to a surface or to both surfaces of a production base for the passivation element, the layer adhering to the production base; b) at least partially drying and/or curing the layer to form a passivation layer. Production of a passivation element by a passivation layer is achieved by at least one of the following steps: cutting the passivation layer to size with or without the production base and/or removing part of the passivation layer from the production base as the passivation element.

### FIELD OF THE INVENTION

The invention relates to the production of a passivation layer made of at least one mass, wherein the mass is dried and/or after a chemical reaction forms a protective layer that has an elongation strength for a first side surface of an adhesive roll. The invention additionally relates to methods for passivating a side surface of an adhesive roll with a passivation element or with a passivation layer and corresponding production methods and to a corresponding passivated adhesive roll.

### BACKGROUND OF THE INVENTION

DE 601 18 442 T2 describes a method for passivating an edge surface of an adhesive strip. Here, the edge surface is coated with a liquid composition of acrylate oligomer and polyether acrylate oligomer. In particular, cloths, sponges, brushes or rollers are used for coating. Spray or immersion coating is also provided.

A method for reducing the winding level adhesion of an adhesive roll is known from WO 2016/131984 A1, in which a carrier foil provided with a passivation layer is coated in a thickness of between 10 nm and 600 nm by means of a plasma current to which a precursor is added, wherein a section of the carrier foil is laid with its passivation coated side onto the winding level of the adhesive strip roll and is pulled off from the carrier foil section.

### SUMMARY OF THE INVENTION

The object of the invention is to conduct the passivation of a side surface of an adhesive roll more simply and safely, and at the same time to manufacture the passivation element.

The object is attained according to the invention by means of a dual-step method, in which, initially, the passivation layer is produced separately and without contact with the adhesive roll, and a portion of said passivation layer is applied to the adhesive roll in its function as a passivation element only after production of the passivation layer. The method for producing a passivation layer has the following steps: a) direct coating of a first surface or both opposite surfaces of a production substrate for the passivation element with the mass, wherein the coating occurs in a thickness of between 0.2 mm and 1.5 mm, or between 0.01 mm and 0.5 mm by means of spray, immersion or squeegee coating or using an offset printing, screen printing, gravure printing or transfer printing method; b) the at least partial drying and/or hardening of the layer to form a passivation layer; c) optional application of further layers onto the respective layer previously applied according to steps a) and b).

The passivation layer is produced on a separate production substrate without contact with the adhesive roll. For this purpose, the production substrate is preferably coated using a printing method. Separated means that the adhesive roll and the production substrate are two different objects. Thus, it is possible to produce the passivation layer ahead of time without the use of an adhesive roll, i.e. manufactured accordingly without storing the production substrate. It is further advantageous that the passivation layer or passivation element is applied onto the adhesive roll just in time following production. Here, the passivation layer can advantageously be designed as a foil, i.e. as a plastic element that is thin relative to its surface with a thickness of a few tenths of a millimetre.

The passivation layer or passivation element have good elongation strength despite their thicknesses, so that the adhesive strip can be rolled off from the adhesive roll that is passivated on both sides and the remaining side surface of the adhesive roll remains entirely protected with the remaining portion of the passivation element. The passivation layer only tears where the adhesive strip is removed from the roll, without detaching itself from the roll. Accordingly, a very thin portion of the passivation layer remains on the edges of the rolled off adhesive strip. After the adhesive strip is rolled off, the remaining passivation layer thus does not protrude on the side surface of the adhesive roll.

The drying or chemical reaction occurs fully or at least predominantly on the production substrate. This is advantageous, since time for applying the passivation layer in the form of the passivation element on the side surface of the adhesive roll can be minimised in this way. A further advantage here is that the adhesion of the passivation element on the side surface is reinforced, since the passivation layer, due to its material properties and in particular in a not yet fully dried-out state, can still adapt to the structure of the side surface of the adhesive roll.

On the other hand, the full drying out on the production substrate is advantageous if the passivation layer is rolled up or stacked for storage, together with the production substrate.

As an alternative to applying a liquid mass, the mass can also be applied in powder form onto the production substrate, and fixed through the influence of heat and the triggering of a chemical reaction. Here, the powder can be converted into a form and dried. The term “mass” is thus open to broad interpretation, and only limits the physical properties to the extent that the mass can be applied in flowable, pourable or fillable form and that the development of the passivation element or passivation layer with the mass must be possible.

With regard to the production of the passivation layer, the method for producing a passivation element has the following advantageous steps: the cutting to size of the passivation layer with or without the production substrate, so that a passivation element is created that can be detached from the production substrate and/or the detachment of a portion of the passivation layer as a passivation element in a concrete form without cutting from the production substrate. Depending on whether the passivation element is directly applied onto the adhesive roll from the production substrate or is first cut to size in an interim step, the adhesive roll can be coated just in time and in just a few seconds. As a result of the cutting to size, the passivation element can either be applied to the adhesive roll with the surface opposite the production substrate or with the surface adhered on the production substrate. If, however, the passivation element is not cut to size and is printed on to the side surface using a type of embossing method, the passivation element adheres to the adhesive roll with the surface opposite the production substrate.

The passivation element or passivation layer adheres simply by laying it onto the side surface of the adhesive roll. This adhesion is improved through the use of an adhesive. The adhesive is cut flush on the sides of the adhesive roll together with the carrier. In addition, as a result of the so-called cold flow, adhesive also emerges out from the side of the adhesive roll. This is advantageous since the lateral adhesion of the adhesive roll is prevented due to the cold flow through the passivation element. The adhesive roll can thus be stored and used for as long as necessary. When the adhesion of the passivation element or the passivation layer is stronger on the side surface of the adhesive roll than on the production substrate, the passivation element can be pressed onto the side surface with the aid of the production substrate.

If the passivation element or passivation layer is further applied to the side surface with the production substrate respectively, this is advantageous, since the production substrate provides an additional protection for the side surfaces and, in particular, protects the passivation element or the passivation layer against mechanical influences. Thus, it is further advantageously possible to store adhesive rolls, the side surfaces of which have been passivated in this manner, stacked on top of each other, without having to insert third protective layers between them which are designed to prevent the adhesion of the passivated side surfaces of adhesive rolls that lie in contact with each other.

The use of a passivation element or a passivation layer as described above is advantageous for passivating the side surface of adhesive rolls used in the construction industry. In the construction industry in particular, adhesive rolls with strong adhesion adhesive materials and relatively thick adhesive layers are used. Due to the relatively thick adhesive layers, the cold flow is increased. However, the construction industry is just one possible area of use; in principle, application is possible for any adhesive roll.

For this purpose, it can also be advantageous when the passivation element has the form of a circle or at least a form that is geometrically similar to or congruent with the side surface. In an advantageous manner, this means that the passivation element, when applied to the side surface, does not protrude, or if so, only minimally. Adhesion of other areas of the adhesive roll is thus prevented and savings are made with regard to material.

The subject of the solution is also a passivation element or a passivation layer, wherein the passivation element or passivation layer does not have a stable form, but is self-supporting and/or elastically formable. An object that does not have a stable form in the sense of the invention clearly and visibly bends under the impact of gravitation. Here, self-supporting means that the object can retain its structure itself under the impact of gravitation and, in particular, does not tear spontaneously. The elastic object, by contrast, permits a reversible extension without plastic deformation. These properties are advantageous, both for manufacture and for the application onto the adhesive roll.

The solution comprises the method in which a) the passivation element or the passivation layer together with the production substrate is adjoined with the adhesive roll as a compound, or b) the passivation element is detached alone from the production substrate and pressed onto the first side surface and is thereby adjoined to the adhesive roll at least via adhesion forces of the passivation element or the passivation layer. The first side surface is therefore advantageously passivated in a single step. Thus, the method is fast, and a high piece number of passivated adhesive rolls per time unit is achieved.

Further, it can be advantageous when the method has the following steps: the cutting to size of the passivation layer or the passivation element alone in a geometrically similar or congruent manner in relation to the side surface. Further, it can be advantageous when the method has at least one of the following three points: a) the production substrate is coated on both sides with a passivation element, b) two adhesive rolls are fed simultaneously, in each case in one of the two Y directions, so that the two adhesive rolls are disposed opposite the rolled goods, c) the simultaneous pressing on of the two adhesive rolls with one side surface each onto the respective passivation layer or the respective passivation element. Series production of the passivation is made possible as a result.

With regard to the production of the passivation layer, the following further steps are advantageous: c) the application of at least one cover layer or a material that differs from the mass onto the layer before or after the at least partial or full drying and/or hardening of the layer. This is followed by the at least partial drying and/or hardening of at least one of the layers to form a connection.

If the passivation element or the passivation layer comprises at least the layer and the cover layer, the elongation at break and the elasticity are optimised through the interplay of its material properties, in particular the elongation and tensile strength. All materials are suitable, in particular also granulates and powders, that do not experience a chemical reaction and which also do not dry out. These then adhere on the layer, for example, when it has fully hardened prior to application. The powder or granulate can advantageously lead to an enlargement of the surface of the passivation element or the passivation layer. It is particularly advantageous when the cover layer is applied before full hardening or reaction of the layer. In this case, granulates and powders in particular can penetrate into the layer. The layer and the cover layer can also be made of the same masses. In this manner, the thickness of the passivation layer in particular can be influenced. Advantageously, the thickness of the layers and the cover layer can be the same or also different. The material parameters can thus be further optimised. In addition, this further cover layer could also be designed as an imprint, with which information is shown in the form of images and/or texts. Here, the layer serves as a carrier layer for an imprint.

The formation of the cover layer also permits the control of the adhesive properties of the two sides of the passivation layer. It can namely be advantageous when the passivation layer or the passivation element has a self-adhesive property on the surface facing away from the production substrate and/or on the surface facing towards the production substrate. If the passivation layer or the passivation element has a self-adhesive property on the surface facing away from the production substrate, it adheres better on the side surface. If the passivation layer or the passivation element has a self-adhesive property on the other, opposite surface, it adheres better on the production substrate, however. Both are advantageous, depending on the application. In particular, depending on the adhesive strength of the adhesive roll, it can be guaranteed through targeted formation of the self-adhesive properties that the passivation element adheres more strongly on the adhesive roll than on the production substrate.

Also advantageous is the production of a passivation layer as described, wherein at least the production substrate that is coated with the passivation layer is rolled up into rolled goods. Storage as rolled goods is advantageously particularly space-saving and application on the side surface is further conveniently possible due to the ease with which the rolled goods can be unrolled.

Further, it can be advantageous when the passivation element or the passivation layer has an average thickness of between 0.02 mm and 1.5 mm, in particular between 0.05 mm and 0.1 mm. Due to the thickness of the passivation element, the elongation strength and elasticity in particular can be controlled. The claimed thickness combines these parameters in a particularly advantageous manner. Other material properties known to a person skilled in the art can also be set via the thickness.

Further, it can be advantageous when the passivation element or passivation layer has a surface area of between 50 cm² and 600 cm², in particular between 125 cm² and 175 cm². Due to these surface areas of the passivation element or passivation layer, it is possible in an advantageous manner to optimise the production with regard to piece numbers and also to passivate the side surfaces of the usual adhesive rolls in a single step.

Further, it can be advantageous when the passivation element or the passivation layer has a specific elongation or tensile strength in accordance with DIN EN ISO 527 of between 0.01 N/mm² and 10 N/mm² and an elongation at break longitudinally and laterally of less than 20%, preferably less than 5%. These material properties advantageously guarantee the most optimal possible tearing of the passivation layer.

It can also be advantageous when the passivation element is printed or coated on at least one side at least partially with a colour. This enables in particular the application of signs, warning information and/or type names.

Additionally, it can be advantageous when the method has the following further steps: a) the unrolling of the rolled goods in an X direction; b) the bringing together of the first side surface with the passivation element or with the passivation layer in a Y direction, essentially at right-angles to the X direction; c) the detaching of the adhesive roll together with the passivation element from the production substrate; d) the subsequent guiding of the rolled goods in the X direction; d) the repeating of steps b) to d) with additional adhesive rolls.

### BRIEF DESCRIPTION OF THE DRAWINGS

Further advantages and details of the invention are explained in the description and in the figures, in which:

FIG. 1a-d shows the production of a passivation element or a passivation layer and a method for passivating an adhesive roll;

FIG. 2 I-IV shows further methods for passivating an adhesive roll;

FIG. 3 shows a profile through the passivation layer or passivation element with a layer;

FIG. 4 shows a profile through the passivation layer or passivation element with two layers of the same thickness;

FIG. 5 shows a profile through the passivation layer or passivation element with two layers of different thicknesses;

FIG. 6 shows a profile through the passivation layer or passivation element with a cover layer made of a powder or granulate.

### DETAILED DESCRIPTION OF THE INVENTION

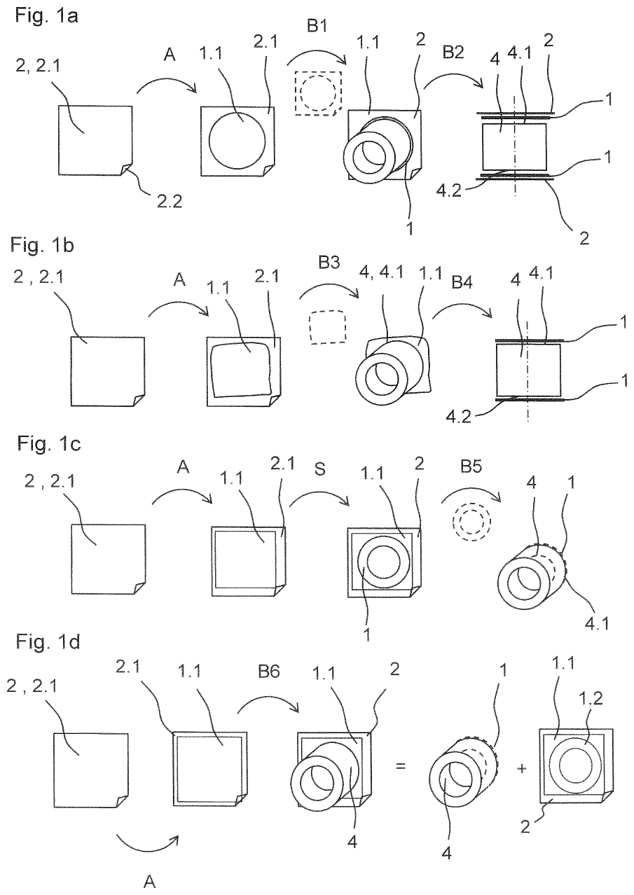

The methods shown in FIGS. 1a to 1d for producing a passivation element 1 or passivation layer 1.1. for passivating an adhesive roll 4 initially differ in the manner in which the passivation element 1 or passivation layer 1.1 is applied to a first side surface 4.1 of the adhesive roll 4. In all methods, in a first step A according to FIGS. 1a to 1d, a first layer 1a of a viscous mass is applied on a first surface 2.1 of a production substrate 2. The viscous mass can also be rolled out on a second surface 2.2 of the production substrate 2. This dries and/or reacts at least partly chemically and as a result forms a passivation layer 1.1 which adheres on the production substrate 2, has elongated strength and has elastic properties. The form that is here created by the passivation layer 1.1 on the production substrate 2 is variable depending on the area of use. According to FIG. 1a, the production substrate 1.1 is applied in the form of a circle; according to FIG. 1b, the passivation element 1 is applied to the production substrate 2 in a geometrically undefined manner; according to FIGS. 1c and 1d, the passivation element 1 is in turn a square or at least a rectangle.

In a step B1 of the method according to FIG. 1a, the production substrate 1.1 together with the production substrate 2 is now placed onto a first side surface 4.1 of an adhesive roll 4. Through this placement, an adhesion between the passivation layer 1.1 and the adhesive roll 4 is achieved. In the following step B2, a passivation layer 1.1 with the production substrate 2 is applied in the same manner to a second side surface 4.2 of the adhesive roll 4. In a following optional further method step, although one that is not shown, the production substrates 2 are removed from the passivation layer 1.1. The passivation elements 1 thus created remain on the adhesive roll 4. In the areas in which the production substrate 1.1 does not adhere to the adhesive roll 4, it is removed from the adhesive roll 4 together with the production substrate 2.

The method according to FIG. 1b pursues another path. Instead of laying the passivation layer 1.1 onto the first side surface 4.1, this is separated or pulled off from the production substrate 2 in step B3. Through the pulling off, a passivation element 1 is created that is processed separately without the production substrate 2. The passivation element 1 is here self-supporting and adheres on the first side surface 4.1. Finally, in step B4, the second side surface 4.2 of the adhesive roll 4 is equipped with the same type of passivation element 1. In a subsequent optional additional method step, although one that is not shown, areas of the passivation layer 1.1 that do not adhere to the adhesive roll 4 are removed from the adhesive roll 4.

According to FIG. 1c, the passivation layer 1.1 is applied to the production substrate 2 in the form of a square. In a step S, after drying and/or hardening, the production substrate 1.1 is cut to size on the production substrate 2. As a result of this cutting to size, the passivation element 1 is created in the form of a circle. In step B5, the passivation element 1 is applied without the production substrate 2 on the first side surface 4.1 of the adhesive roll 4. This final step is repeated for the second side surface 4.1 of the adhesive roll 4.

In the method presented in FIG. 1d, after step A, the adhesive roll 4 is placed with its first side surface 4.1 on the passivation layer 1.1 in step B6. Here, the passivation layer 1.1 adheres to the adhesive roll 4 in the area of the first side surface 4.1. When the adhesive roll 4 is removed, the passivation layer 1.1 adhering to the adhesive roll 4 is detached from the production substrate 2, as a result of which the passivation element 1 is created, which adheres to the adhesive roll 4, and as a result of which at the same time, a gap 1.2 is created in the passivation layer 1.1. This method can be described as a type of embossing method, in which the passivation layer 1.1 is detached by pressing on and lifting off the adhesive roll 4 from the production substrate 2.

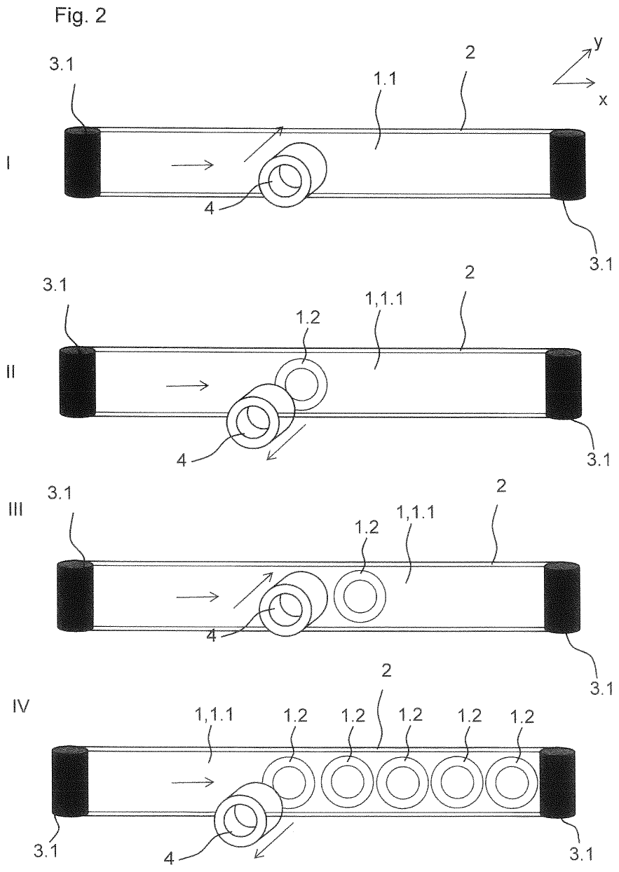

In particular, the automated passivation of adhesive rolls is possible by means of a method that draws on the method described above according to FIG. 1d, and which is shown in FIG. 2. After Step I, the passivation layer 1.1 is applied to a strip-shaped production substrate 2, which is produced as rolled goods 3.1 and which is tensioned in an X direction. The rolled goods 3.1 are unrolled to the left and after passivation are rolled up to the right. The adhesive roll 4 is pressed onto the passivation layer 1.1 in a Y direction at right-angles to the X direction, as a result of which the passivation layer 1.1 adheres to the adhesive roll 4 in the area of contact with the adhesive roll 4. After detaching the adhesive roll 4 from the production substrate 2 according to step II, a gap 1.2 is created in the passivation layer 1.1 in the form of the passivation element 1. In order to passivate the next adhesive roll 4, according to step III, the rolled goods 3.1 are subsequently guided at least around the breadth of the adhesive roll 4 in the X direction and a further adhesive roll 4 is fed to the passivation layer 1.1. As is shown in step II, the first side surface 4.1 of the adhesive roll 4 is then connected with the passivation layer 1.1. After the adhesive roll 4 has been detached, the passivation layer 1.1 or passivation element 1 is subsequently guided in the X direction via the rolled goods 3.1. On the first side surface 4.1 of the adhesive roll, the passivation element 1 remains adhered.

Through repetition of these steps I to II, a production substrate 1.1 with gaps is created as shown in step IV, which is continuously rolled up to the right. The system of coordinates shown defines the X and Y directions and relates to all method steps. Even if the Y direction runs at the side, as shown here, progression upwards or downwards is also possible in the sense of the definition.

The method shown in FIG. 2 can also be conducted simultaneously from both sides of the production substrate 2 with a production substrate 2 coated on both sides.

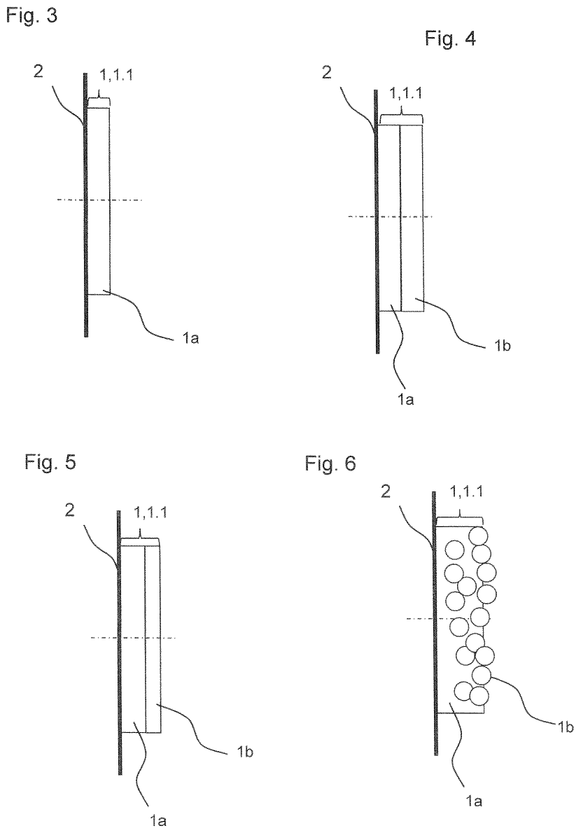

The passivation element 1 or passivation layer 1.1 according to FIG. 3 has a layer 1a of the mass which after drying does not have a stable form, but is self-supporting. The passivation element 1 or passivation layer 1.1 according to FIGS. 4 and 5 has a layer 1a of the mass and a cover layer 1b of a material that differs from the mass. Both layers 1a, 1b form a compound. Both layers, 1a, 1b have the same thickness according to FIG. 4, while according to FIG. 5, the layer thicknesses are different. Thus, layer 1a is thicker than the cover layer 1b. According to FIG. 6, the material of the cover layer 1b is a powder or granulate that does not harden and does not react chemically. Since it has been applied to layer 1a before full hardening or chemical reaction of layer 1a, it has at least partially penetrated into layer 1a. The layer 1a and the cover layer 1b form a compound.

What is claimed is:

1. A production of a passivation layer made of at least one mass, wherein the mass is dried and/or after a chemical reaction forms a protective layer that has an elongation strength for a first side surface of an adhesive roll
wherein the method comprises the following steps:
a) direct or indirect coating of a first surface or both opposite surfaces of a production substrate for a passivation element with the mass, wherein the coating occurs in a thickness of between 0.2 mm and 1.5 mm, or between 0.01 mm and 0.5 mm by spray, immersion or squeegee coating or using an offset printing, screen printing, gravure printing or transfer printing method;
b) the at least partial drying and/or hardening of the layer to form a passivation layer.

2. The production of a passivation layer according to claim 1, with the following additional steps:
c) application of at least one cover layer or a material that differs from the mass onto the layer before or after the at least partial or full drying and/or hardening of the layer.

3. The production of a passivation layer according to claim 1,
wherein the production substrate that is at least coated with the passivation layer is rolled up into rolled goods.

4. The production of a passivation element with a passivation layer according to claim 1 by at least one of the following steps:
cutting to size of the passivation layer with or without the production substrate and/or
detachment of a part of the passivation layer from the production substrate as a passivation element.

5. The passivation element produced according to claim 4, wherein the passivation element or the passivation layer does not have a stable form, but is self-supporting and/or elastically formable.

6. The passivation element or passivation layer according to claim 1, wherein the passivation element or the passivation layer has an average thickness of between 0.02 mm and 1.5 mm.

7. The passivation element or passivation layer according to claim 1, wherein the passivation element or the passivation layer has a surface area of between 50 cm² and 600 cm².

8. The passivation element or passivation layer according to claim 1, wherein the passivation element or the passivation layer has a specific elongation or tensile strength in accordance with DIN EN ISO 527 of between 0.01 N/mm² and 10 N/mm² and an elongation at break longitudinally and laterally of less than 20%.

9. A method for passivating a first side area of an adhesive roll with a passivation element or with a passivation layer that does not have a stable form but is self-supporting and/or elastically formable, using the production method according to claim 1, wherein the passivation element or the passivation layer together with the production substrate is adjoined with the adhesive roll as a compound, or the passivation element is detached alone from the production substrate and pressed onto the first side surface and is thereby adjoined to the adhesive roll at least via adhesion forces of the passivation element or the passivation layer.

10. The method according to claim 9, wherein the method has the following steps: the cutting to size of the passivation layer or the passivation element alone in a geometrically similar or congruent manner in relation to the first side surface.

11. The method according to claim 9, wherein the method has the following steps:
a) unrolling of the rolled goods in an X direction;
b) bringing together of the first side surface with the passivation element or with the passivation layer in a Y direction, essentially at right-angles to the X direction;
c) detaching of the adhesive roll together with the passivation element from the production substrate;
d) subsequent guiding of the rolled goods in the X direction;
e) repeating of steps b) to d) with additional adhesive rolls.

12. The production of a passivation layer according to claim 2, wherein the production substrate that is at least coated with the passivation layer is rolled up into rolled goods.

13. The production of a passivation element with a passivation layer according to claim 12 by at least one of the following steps:
cutting to size of the passivation layer with or without the production substrate and/or
detachment of a part of the passivation layer from the production substrate as a passivation element.

14. The passivation element produced according to claim 13, wherein the passivation element or the passivation layer does not have a stable form, but is self-supporting and/or elastically formable.

15. The passivation element or passivation layer according to claim 6, wherein the passivation element or the passivation layer has an average thickness of between 0.05 mm and 0.1 mm.

16. The passivation element or passivation layer according to claim 15, wherein the passivation element or the passivation layer has a surface area of between 125 cm² and 175 cm².

17. The passivation element or passivation layer according to claim 16, wherein the passivation element or the passivation layer has a specific elongation or tensile strength in accordance with DIN EN ISO 527 of between 0.01 N/mm² and 10 N/mm² and an elongation at break longitudinally and laterally of less than 5%.
